(19) United States
(12) Patent Application Publication
(10) Pub. No.: US 2016/0076484 A1
(43) Pub. Date: Mar. 17, 2016

(54) TURBOJET ENGINE NACELLE THRUST REVERSER COMPRISING CASCADES SECURED TO THE MOBILE COWLS

(71) Applicant: AIRCELLE, GONFREVILLE L'ORCHER (FR)

(72) Inventor: Guy Bernard VAUCHEL, HARFLEUR (FR)

(73) Assignee: AIRCELLE, GONFREVILLE L'ORCHER (FR)

(21) Appl. No.: 14/950,479

(22) Filed: Nov. 24, 2015

Related U.S. Application Data
(63) Continuation of application No. PCT/FR2014/005134, filed on Jun. 5, 2014.

(30) Foreign Application Priority Data
Jun. 7, 2013 (FR) 13/55279

(51) Int. Cl. F02K 1/72

(52) U.S. Cl. CPC F02K 1/72

(57) ABSTRACT

A thrust reverser of a turbojet engine nacelle includes mobile cowls which retreat with respect to a front frame while causing via cylinders the tipping of the shutters initially folded inside these cowls, so as to substantially close an annular stream of cold air, and cascades disposed around the annular stream which receive the cold air flow in order to send it towards the front. In particular, the cascades are secured to the mobile cowls and slide.

### CROSS-REFERENCE TO RELATED APPLICATIONS

This application is a continuation of International Application No. PCT/FR 2014/051349, filed on Jun. 5, 2014, which claims the benefit of FR13/55279, filed on Jun. 7, 2013. The disclosures of the above applications are incorporated herein by reference in their entirety.

### FIELD

The present disclosure relates to a thrust reverser for an aircraft nacelle receiving a turbojet engine, as well as an aircraft nacelle equipped with such a thrust reverser.

### BACKGROUND

The statements in this section merely provide background information related to the present disclosure and may not constitute prior art.

The motorization assemblies for aircrafts generally include a nacelle forming a globally circular external casing, comprising inside a turbojet engine disposed along the longitudinal axis of this nacelle.

The turbojet engine receives fresh air coming from the upstream or front side, and discharges from the downstream or rear side the hot gases coming from the fuel combustion, which provide a certain thrust. For the dual flow turbojet engines, fan blades disposed around this turbojet engine generate an important secondary flow of cold air along an annular stream passing between the engine and the nacelle, which adds a high thrust.

Some nacelles include a thrust reversal system which at least partly closes the annular stream of cold air, and discharges the secondary flow towards the front in order to generate a braking thrust of the aircraft.

A known type of thrust reverser, in particular presented by Document EP 0321993 A2, includes rear mobile cowls which can axially slide towards the rear as a result of actuators, by deploying shutters in the annular stream for closing this stream at least partially. These shutters send back the cold air flow radially towards the outside by passing via cascades uncovered during this sliding, comprising vanes which direct this flow towards the front.

When the thrust reverser is closed, the cascades are integrated within the thickness of the mobile cowls, the shutters being folded below these cascades, under their lower faces turned towards the axis of the nacelle.

Each cascade is secured by an articulation to the front frame being upstream of the mobile cowls. Telescopic cylinders disposed longitudinally in the annular stream, have their front ends secured to the inside of the front frame, and their rear ends secured to the inside of a shutter.

When the mobile cowls retreat the telescopic cylinders start by extending, and when arrived at the end of travel pull the shutters towards the inside of the nacelle so as to deploy them in the annular stream.

The issue posed with this type of thrust reverser, is that the cylinders remaining in the annular stream during the normal operation of the turbojet engine, inhibit the cold air flow and increase consumption.

Another type of known thrust reverser, presented in particular by U.S. Pat. No. 5,228,641, includes cascades secured to the front frame, which are integrated in the thickness of the mobile cowls when the thrust reverser is closed. The shutters disposed below the cascades, include a front end connected to the mobile cowl by an articulation, and a rear end connected by a coupling link starting from the rear, to a connecting arm which returns to the front so as to be secured on the front frame.

The retreating of the mobile cowls causes the coupling links and the shutters thereof to tip over and descend into the annular stream in order to close it. These types of thrust reversers comprising cascades as well as the shutters with their control systems, integrated in the mobile cowls when the thrust reverser is closed, pose encumbrance issues which require reducing the size of the cascades in order to be able to insert them in these cowls. However, the aerodynamic performance of these cascades is lacking.

### SUMMARY

The present disclosure includes a thrust reverser of a turbojet engine nacelle, comprising mobile cowls which retreat with respect to a front frame while causing via cylinders the tipping of the shutters initially folded inside these cowls, so as to substantially close the annular stream of cold air, and the opening of cascades disposed around this stream which receive the cold air flow in order to send it towards the front, characterized in that the cascades are secured to the mobile cowls and slide therewith.

An advantage of this thrust reverser is that since the cascades are outside the mobile cowls, cowls can be easily produced comprising a reduced radial thickness, which receive in an integrated manner the shutters as well as their control mechanisms comprising the cylinders. Thereby, these control mechanisms with the cylinders do not surpass in the annular stream of cold air, this stream may include a good aerodynamic profile providing the performances of the propulsion system. In addition, the cascade disposing of a less limited space, may include a shape which is better suited for the deflection of the flow.

The thrust reverser according to the present disclosure may in addition include one or several of the following features, which may be combines together.

According to one form, the shutters include a front end connected by an articulation to a mobile cowl, and a cylinder comprising a front end secured to the frame, and the other end secured to the rear of this shutter.

Advantageously, the cylinder is at the boundary of the external surface of the annular stream, the shutter being connected to the mobile cowl by an articulation which is distant from this cylinder radially towards the outside. Thus, by this distance it is obtained when the shutter is folded, a thrust of the cylinder providing a torque force on this shutter which maintains it pressed on its end of travel stop.

Advantageously, the cylinder disposed in the longitudinal axis of the shutter, is integrated in a longitudinal hollow of the face of the shutter turned radially towards the inside of the nacelle, thus inhibiting this cylinder surpassing in the annular stream.

Advantageously, the cylinder includes below a closing plate secured flat along the length, which is adjusted on the face of the shutter when it is folded so as to substantially close the longitudinal hollow of this shutter. This plate improves the aerodynamic surface of the annular stream.

Advantageously, the closing plate has its rear end secured to the rear part of the rod of the cylinder and its front end slidably secured onto the body of this cylinder by a linear guiding. In thrust reversal, this plate is spaced apart from the air flow so as not to inhibit it.

Advantageously, the rear part of the shutter radially bears outwards when the thrust reverser is closed, on an adjustable end of travel stop which allows adjusting the alignment of this shutter with the adjacent surfaces.

Advantageously, the rear end of the cascades is secured to a spoiler found at the front of the mobile cowls, a sealing member bearing on the front frame, which is radially inside the cascades.

Advantageously, the thrust reverser includes at the front of the mobile cowls, a seal member bearing on the front frame. This seal provides a pressure balance facilitating the opening or closing of the cowls.

Advantageously, the front ends of the cascades are connected together by a circular structure which is upstream of the front frame, this structure providing strong stiffness with a reduced mass.

Another object of the present disclosure is a turbojet engine nacelle including a thrust reverser comprising any one of the previous features.

Further areas of applicability will become apparent from the description provided herein. It should be understood that the description and specific examples are intended for purposes of illustration only and are not intended to limit the scope of the present disclosure.

### DRAWINGS

The present disclosure will be well understood and other features and advantages will also appear more clearly upon reading the following description, given by way of example with reference to the accompanying drawings in which:

FIG. 1 is a partial view in axial section passing via the center of a shutter, of a thrust reverser according to the present disclosure which is closed;

FIG. 2 is a transversal sectional view of this shutter;

FIG. 3 is a longitudinal detailed sectional view showing the sealing system of the mobile cowls;

FIG. 4 shows the thrust reverser at the start of the opening, comprising the cylinder being extended;

FIG. 5 shows the thrust reverser more open, comprising the cylinder in complete extension;

FIG. 6 shows the thrust reverser even more open, comprising the shutter being deployed;

FIG. 7 shows the thrust reverser completely open, comprising the shutter entirely deployed; and

FIGS. 8 and 9 show the thrust reverser respectively closed and entirely open, comprising a sliding cylinder fairing.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

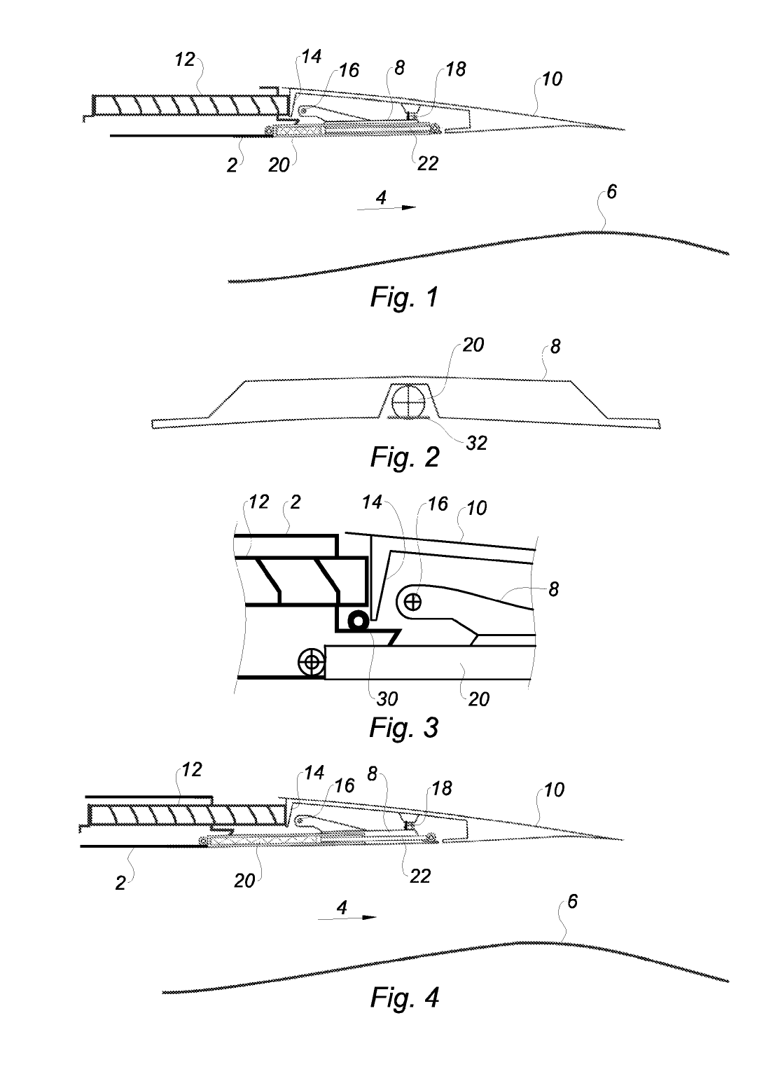

FIGS. 1 and 2 show a rear part of a turbojet engine nacelle, comprising a front frame 2 secured onto the structure which is upstream of this part, and mobile cowls 10 adjusted behind this frame.

The rear part of the nacelle is covered by two mobile cowls 10, each forming a half-circle in a transversal plane. Each cowl 10 is axially guided by longitudinal guiding means which allow a sliding towards the rear as a result of non-represented actuators, bearing on the stationary structure upstream of the mobile cowls 10. The cowls 10 include a locking system in closed position, which is not represented.

In a variant, the nacelle may include a single annular mobile cowl 10, which similarly slides towards the rear to open the thrust reverser.

The secondary annular stream 4 includes a radially outer contour comprising shutters 8 adjusted inside the mobile cowls 10 so as to give an aerodynamic continuity, and a radially inner contour formed by the stationary inner structure 6.

Cascades 12 disposed flat around the annular stream 4, form a crown entirely integrated within the front frame 2 when the thrust reverser is closed.

The rear end of the cascades 12 is secured to a spoiler 14 found at the front of the mobile cowls 10, which forms a fold-back from the external surface of these cowls, towards the center of the nacelle. The cascades may slide freely through openings of the front frame 2, so as to follow the movement of the cowls 10 when the thrust reverser opens.

The system for driving the cowls 10 comprising the actuators may be secured on the upstream part of the cascade structure 12, to displace the assembly comprising the cascades and the cowls. This disposition entirely releases the passage of the air in the cascade structure 12 in thrust reversal, but encroaches on the front cowl of the engine.

In a variant the cowl driving system 10 may be secured on the cascades 12, either in the plane of the cascades, or radially above or below the structure thereof. The cowl driving system 10 may also be secured on the upstream part of the structure of these cowls, by being integrated between two cascade elements 12. In these two variants the drive system is in the passage of the air in thrust reversal mode.

Each shutter 8 includes an arm extending towards the front inside the mobile cowl 10, terminating at the front end thereof by an articulation 16 connected to this mobile cowl, which is disposed just behind the fold-back spoiler 14.

The rear part of the shutter 8 radially bears towards the outside on an end of travel stop 18, which positions this shutter so as to adjust the face thereof in the continuity of the internal surfaces of the front frame 2 and the mobile shutter 10. The end of travel stops 18 may be adjustable, so as to refine the position of the shutters 8 in the aerodynamic flow.

Each shutter 8 includes a telescopic cylinder 20 disposed in the longitudinal axis of this shutter, which is entirely integrated in a longitudinal hollow of the face of the shutter turned towards the inside of the nacelle, so as to be adjusted on the external surface of the annular stream 4 without surpassing in this stream. The front end of the cylinder 20 is secured by a pivot to the front frame 2, the rear end is also secured by a pivot, to a rear part of the shutter 8.

Each telescopic cylinder 20 includes a body containing on the front side a helical compression spring, which exerts pressure on the front end of the rod 22 thereof, in order to push it backwards so as to put this cylinder in extension.

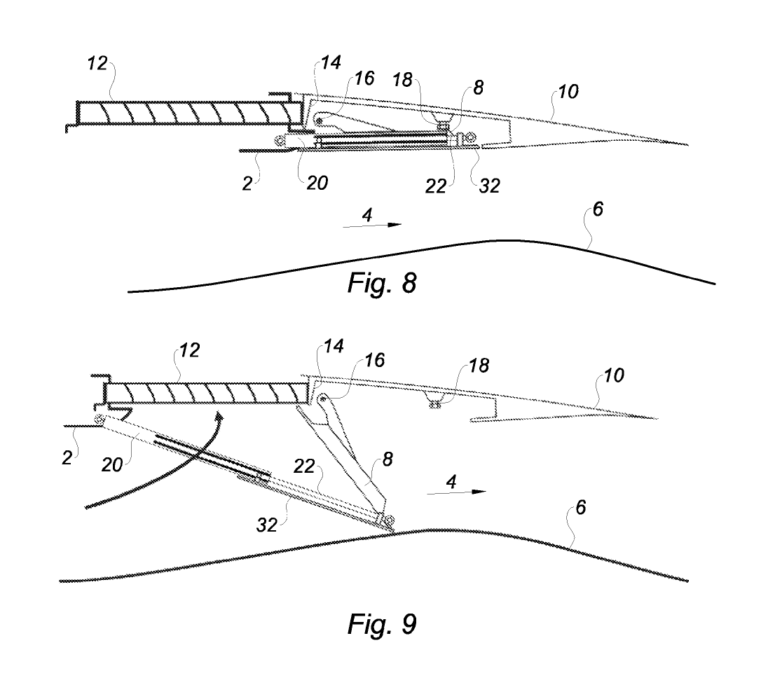

A closing plate 32 secured flat under the cylinder 20 along the length thereof, forms a slidable fairing adjusted on the face of the shutter 8 when it is folded, forming the longitudinal hollow of this shutter so as to improve the external aerodynamic profile of the annular stream 4. This closing plate 32 mounted as an option, is shown on FIGS. 8 and 9.

It is worth noting that the shutters 8 are maintained under tension by the pressure of the cylinder springs 20 which tend to push them on their end of travel stops 18, with a certain torque depending on the radial distance between the axis of this cylinder and the articulation 16 of the shutters. This pressure inhibits the floating of the shutters 8 which would inhibit the output rate of secondary air.

FIG. 3 shows a cowl 10 in its forward position, the thrust reverser being entirely closed.

The radially internal end of the fold back spoiler 14 bears forward on a sealing member 30, which itself bears on the front frame 2, radially inside the cascades 12. The disposition of the cascades 8 integrated upstream of the mobile cowl 10 structure, allows this disposition of the seal which achieves a pressure balance facilitating the opening or closing of these cowls.

FIG. 4 shows the thrust reverser at the start of the opening, the mobile cowls 10 having started to retreat as a result of the actuators thereof. The cascades 12 start coming out of the front frame 2.

The cylinders 20 are extending. Their rods 22 having not entirely come out, these cylinders 20 may continue to be deployed without exerting a retaining force on the rear part of the shutters 8 which do not tip over, and remain pressed inside the mobile cowls 10.

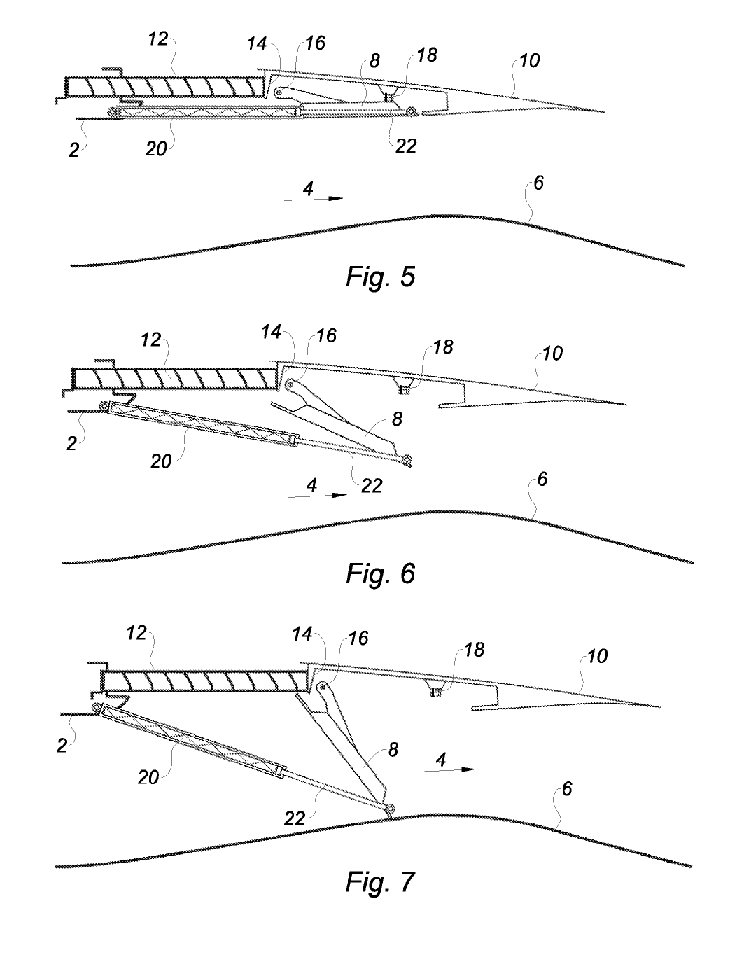

FIG. 5 shows the thrust reverser more open, with the mobile cowls 10 which continue to retreat. The cylinders 20 reach their complete extension with the rods 22 entirely out, but the shutters 8 still do not tip over.

FIG. 6 shows the thrust reverser even more open, the rod 22 which can no longer retreat, has started to make the shutter 8 tip over by pulling the rear part thereof downwards.

FIG. 7 shows the thrust reverser entirely open, the mobile cowls 10 are in their maximum rear positions, the shutters 8 are completely lowered when arriving near the inner stationary structure 6.

During these different steps shown by FIGS. 5, 6 and 7, the cascades 12 come further and further out of the front frame 2, to end up completely out so as to clear their entire surfaces, which allow deflecting the secondary flow.

Advantageously, the front ends of the assembly of cascades 12 are connected together by a continuous circular structure which is found upstream of the front frame 2, thus allowing in a simple manner with a reduced mass to obtain a particularly stiff assembly of cascades. The length of the cascades 12 is suited accordingly, so that their front ends remain upstream of this frame 2 when the thrust reverser is entirely open.

For the closing of the thrust reverser, the compression of the cylinder springs 20 as well as the air flow in the secondary stream 4, push the shutters 8 backwards. There are the reverse movements with first a folding of the shutters 8 inside the mobile cowls 10, prior to the compression of the springs.

It is thereby obtained a simple inexpensive system, disposing of mobile cowls 10 which may include a reduced thickness as on the one hand the cascades 12, and on the other hand the shutters 8 with their maneuvering systems comprising the cylinders 20, are axially one after the other without being superimposed. In addition it is not necessary to provide a space in these mobile cowls 10 for housing the cascades 12.

With the cylinders 20 integrated in the shutters 8, which do not surpass in the annular stream 4, the internal and external aerodynamic profiles of this stream may be improved, and the fuel consumption is improved.

It is worth noting that the space available in the mobile cowls 10 having no cascades 12, allows to adjust the position of the front articulation 16 of the shutters 8, which may be near the external surface of these cowls in order to obtain with the choice of the anchoring points of the cylinders 20, good kinematics for deploying the shutters. Particularly a rather important radial spacing between the cylinders 20 and the front articulation points 16 of the shutters 8, allows these cylinders to maintain a strong torque on the folded shutters. A good distribution of forces and a better maneuvering reliability is also provided.

Furthermore, it is easier for the mobile cowls 10 which do not have a free internal volume for the cascades, to have a stiff structure produced.

FIGS. 8 and 9 show the closing plate 32 having the rear end thereof secured to the rear part of the cylinder rod 22, and the front end thereof slidably secured on the body of this cylinder by a linear guiding, such as a guiding rail.

In direct jet mode for the propulsion of the aircraft, shown by FIG. 8, the longitudinal hollow of the shutter 8 is closed by the plate 32 forming a fairing for improving aerodynamic performances.

In reverse jet mode for the braking, shown by FIG. 9, the body of the cylinder 20 is globally released from the closing plate 32 which slides towards the front with the rod 22, allowing a better circumvention of the reversal flow, and thereby an improvement as regards the reversal performances.

What is claimed is:

1. A thrust reverser of a turbojet engine nacelle, comprising a mobile cowl which retreats with respect to a front frame while causing via a cylinder a tipping of a shutter initially folded inside the mobile cowl, so as to substantially close an annular stream of a cold air, and an opening of cascades disposed around the annular stream which receives the cold air so as to send the cold air towards a front, wherein the cascades are secured to the mobile cowl and slide therewith.

2. The thrust reverser according to claim 1, wherein the shutter includes a front end connected by an articulation to the mobile cowl, and a cylinder comprising a front end secured to the front frame, and other end secured to a rear of the shutters.

3. The thrust reverser according to claim 2, wherein the cylinder is at a boundary of an external surface of the annular stream, the shutter being connected to the mobile cowl by the articulation which is distant from the cylinder radially towards an outside.

4. The thrust reverser according to claim 3, wherein the cylinder disposed in a longitudinal axis of the shutter is integrated in a longitudinal hollow of a face of the shutter turned radially towards an inside of the turbojet engine nacelle.

5. The thrust reverser according to claim 4, wherein the cylinder includes below a closing plate secured flat along a length, which is adjusted on the face of the shutter when folded so as to substantially close the longitudinal hollow of the face of the shutter.

6. The thrust reverser according to claim 5, wherein the closing plate comprises a rear end secured to a rear part of a rod of the cylinder, and a front end slidably secured onto a body of the cylinder by a linear guiding.

7. The thrust reverser according to claim 1, wherein a rear part of the shutter radially bears outwards when the thrust reverser is closed, on an adjustable end of travel stop.

8. The thrust reverser according to claim 1, wherein a rear end of the cascades is secured to a spoiler found at a front of the mobile cowl, which forms a fold-back from an external surface of the mobile cowl, towards a center of the turbojet engine nacelle.

9. The thrust reverser according to claim 1, wherein the thrust reverser comprises at the front of the mobile cowl, a sealing member bearing on the front frame, which is radially inside the cascades.

10. The thrust reverser according to claim 1, wherein front ends of the cascades are connected together by a circular structure which is upstream of the front frame.

11. A turbojet engine nacelle including a thrust reverser according to claim 1.
